(19) United States
(12) Patent Application Publication
(10) Pub. No.: US 2015/0149122 A1
(43) Pub. Date: May 28, 2015

(54) HANDHELD DATA COLLECTOR AND ANALYZER SYSTEM

(71) Applicant: Teno Cipri, San Jose, CA (US)

(72) Inventor: Teno Cipri, San Jose, CA (US)

(21) Appl. No.: 14/551,006

(22) Filed: Nov. 22, 2014

Related U.S. Application Data
(60) Provisional application No. 61/907,427, filed on Nov. 22, 2013.

(51) Int. Cl. G01M 99/00; G01M 13/00

(52) U.S. Cl. CPC G01M 99/005; G01M 13/00
USPC 702/190; 702/189

(57) ABSTRACT

A handheld measurement device incorporating both a data collector and an analyzer is disclosed. The data collector of the device receives one or more external input signals and stores the data collected for later retrieval and analysis. In one embodiment these input signals are received from sensors used to collect measurements in machine systems for predictive maintenance purposes. The analyzer using software routines in accordance with a method of the present invention retrieves and processes the collected data using filtering techniques and performs calculations that determine the absence or presence of a machine system defect. Additionally, the handheld measurement device includes a display for providing a user with one or more different visual presentations of the calculated results with respect to the collected measured data or alternatively provides the user the option of transferring the calculated results either directly or wirelessly to the display used with any other computer system.

### CROSS-REFERENCE TO RELATED APPLICATION

The present disclosure claims priority to U.S. Provisional Patent Application Ser. No. 61/907,427, filed on Nov. 22, 2013, entitled “A scalable method for creating and running test sequences, generating reports and creating repair and service tickets using instrumentation”, the entirety of which is incorporated herein by reference.

### TECHNICAL FIELD

The present invention relates in general to handheld test and measurement devices and more particularly to a portable device that combines both a data collector and analyzer for monitoring machine systems and detecting machine fault conditions.

### BACKGROUND ART

Prior art handheld data collector and analyzer devices are generally used to collect vibration measurements from machines or systems for use in predicting maintenance applications. Data collectors use different measurement routines depending on the type of machines or systems, measurement sensors, test points, and set-up conditions for each test point. Typically, based on inputs from the user, the handheld device prompts the user as to the identity of the machine and the test point to be monitored, and automatically sets up the device, for example to record a particular measurement parameter and range for a given test point, conduct a predetermined analysis and store a predetermined set of data. The analyzer uses different software routines based on the previous types of machines or systems chosen and determines for each test point what type of analysis needs to be performed, a particular type or set of data to be stored, and similar other parameters to be analyzed.

However, the above described hand held data collector and analyzer devices and associated measurement techniques have been developed for the collection and data for machines and systems used for a particular industry or sensor application. Furthermore, the resulting analyzed data is only available to the user in limited display formats. Therefore, a need exists for a data collector and analyzer device that can receive the input provided from any signal or sensor data for any machine or system used in any industry and that can display the processed data on any display format that the user chooses.

### SUMMARY OF THE INVENTION

A handheld measurement device incorporating both a data collector and an analyzer is disclosed. The data collector of the device receives one or more external input signals and stores the data collected for later retrieval and analysis. In one embodiment these input signals are received from sensors for example vibration sensors used to collect vibration measurements in machine systems for predictive maintenance purposes. The analyzer using software routines in accordance with a method of the present invention retrieves and processes the collected data using filtering techniques associated with the sensors and machine system being measured and performs calculations that determine the absence or presence of a machine system defect. Additionally, the handheld measurement device includes a display for providing a user with one or more different visual presentations of the calculated results with respect to the collected measured data or alternatively provides the user the option of transferring the calculated results either directly or wirelessly to the display used with any other computer system.

While the preferred embodiment is described herein in connection with vibration, other embodiments of the invention measure other operational parameters of machine systems such as for example, but without limitation, voltage, current, flux, temperature, pressure, force, speed, displacement, energy, color, frequency, etc.

### DESCRIPTION OF THE DRAWINGS

In the accompanying drawings:

FIG. 1 is shown a plan view of one embodiment of a device used as a handheld data collector and analyzer system in accordance with the present invention;

FIG. 2 is a block diagram illustrating one example of the types of different electrical and software modules and external hardware in accordance with the present invention; and

FIG. 3 is a captured display device screenshot illustrating an example of a graphical representation of the resulting data results as requested by a user's input.

### DESCRIPTION OF EMBODIMENTS

In the following discussion, numerous specific details are set forth to provide a thorough understanding of the present invention. However, those skilled in the art will appreciate that, unless indicated otherwise, all functions described herein may be performed in either hardware or software, or some combination thereof or in a manual, non-computerized way. In a preferred embodiment, however, the functions are performed by a processor, such as a computer or an electronic data processor, in accordance with code, such as computer program code, software, and/or integrated circuits that are coded to perform such functions, unless indicated otherwise. While the exemplary embodiments illustrated herein may show the various embodiments of the invention (or portions thereof) collocated, it is to be appreciated that the various components of the various embodiments may be located at distant portions of a distributed network, such as a local area network, a wide area network, a telecommunications network, social network, an intranet and/or the Internet, or within a dedicated object handling system.

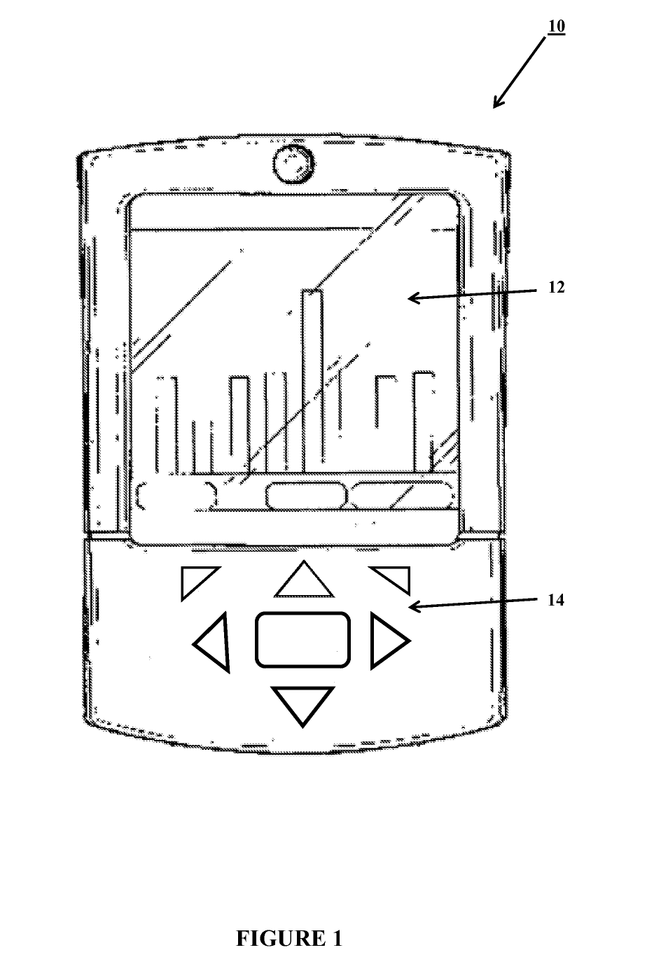

Referring now to FIG. 1, there is shown a plan view of one embodiment of a device 10 for use as a handheld data collector and analyzer system in accordance with the present invention. Although not shown in FIG. 1, the device 10 is designed to electrically receive one or more analog inputs. By way of example only, the device 10 may provide from four to eight single-ended analog inputs using digital counters, TTL-level digital-switch input lines, and TTL-level digital-switch output lines. Furthermore, the device 10 houses a graphical digital display screen 12 shown by way of example located at the top area of device 10 for allowing a user (not shown) to view data results. In this example, the lower area of device 10 shows menu selection buttons 14 that in association with the display screen 12 that allows a user to interface and control different software features offered by the device 10 in addition to viewing the data results.

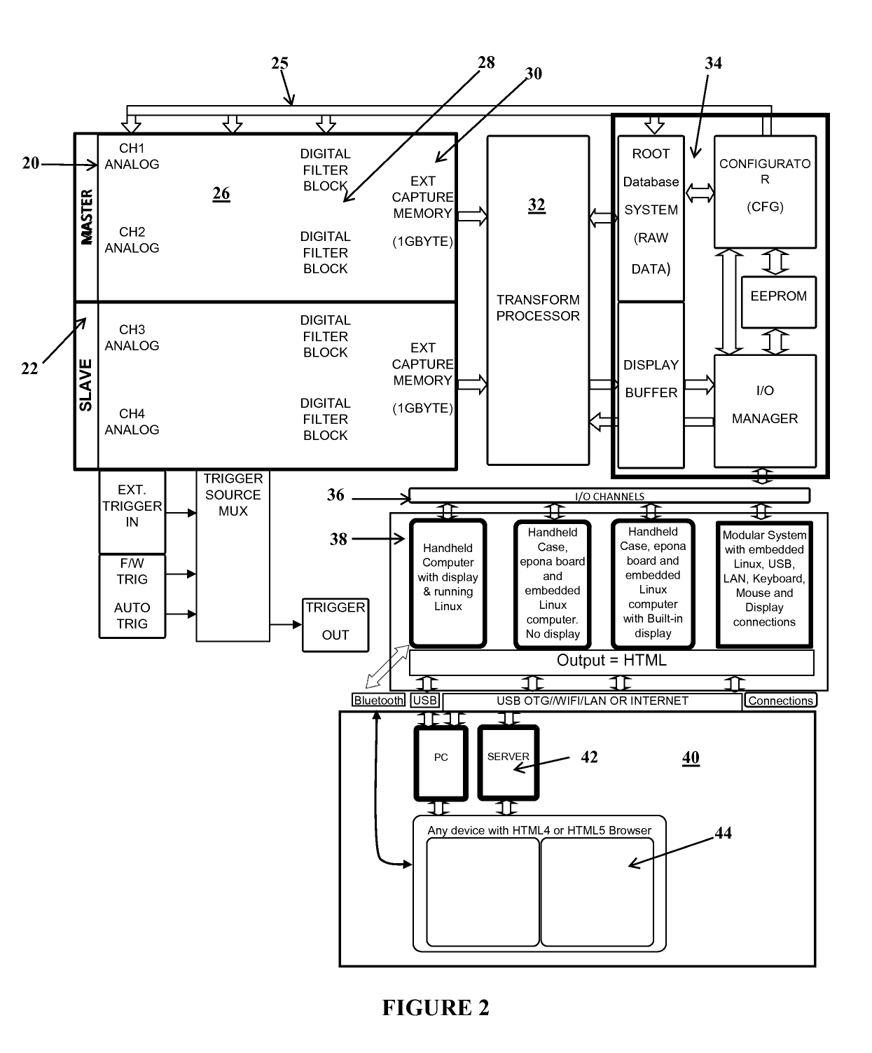

Referring now to FIG. 2, there is shown a block diagram illustrating one example of the types of different electrical and software modules and external hardware that when interconnected in electrical communication 26 to each other result in an electronic system that maybe is used for the handheld data collector and analyzer in accordance with the present invention. As shown in FIG. 2, the primary modules used in one data collector and analyzer of the present invention comprises a master module 20 having an associated slave module 22. Turning once again to FIG. 2, the master 20 and slave 22 provide as many analog channels or electrical interface connections as needed to perform a specific test. In the example shown in FIG. 2, there are shown 4 analog channels which is by way of example only and not of limitation a typical four (4) channel multi-meter (not shown.

Referring once again to FIG. 2 the master and slave modules 20 and 22 respectively receive analog input signals from measurement sensors (not shown) which are then processed by digital block filters 28 which in turn are cached by external memory 30 and sent to transform processor 32 that performs the required data calculation depending on the machine or system under test to produce data analysis end results requested by the user at the beginning of a test measurement sequence. The transform processor 32 then sends this data to display processing modules 34 that assist in formatting the data results send to an input/output bus line 36 for delivering the data results to one or more selected display's 38 chosen by the user at the beginning of a test sequence. Lastly, there is shown a USB protocol subsystem 40 for delivering these same results directly or wirelessly in real time to one or more USB ported devices 42 or any system 44 such as a desktop or laptop which has a display screen having an HTML browser.

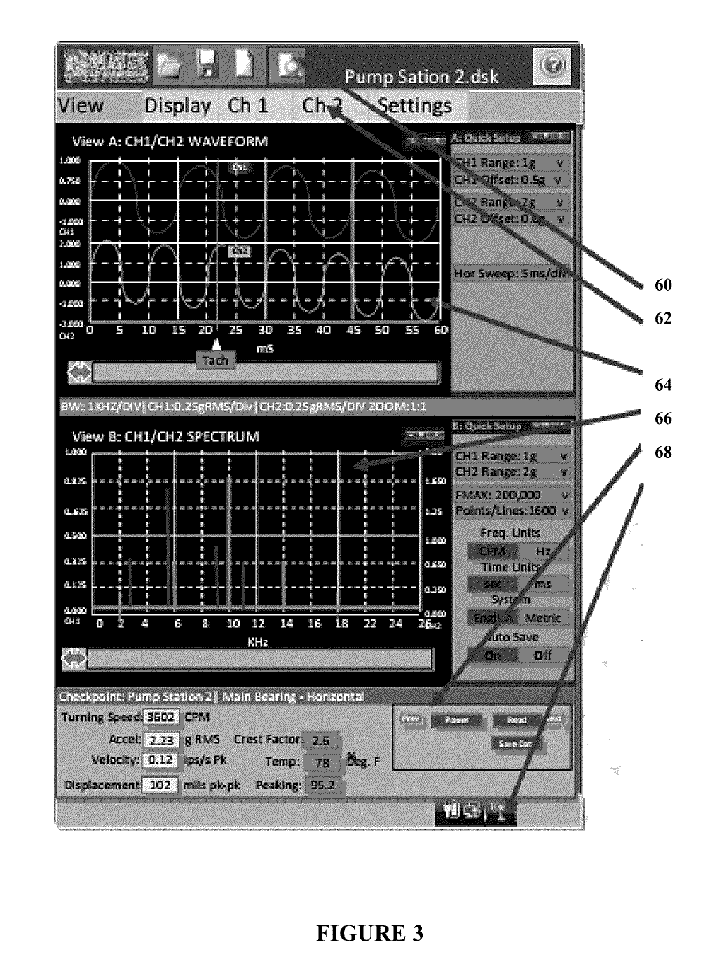

Referring now to FIG. 3, there is shown a captured screenshot 50 illustrating an example of a graphical representation of the resulting data results as requested by a user's input. Turning once again to FIG. 3, a dashboard type icon 60 is illustrated at the top of the display screen wherein two different graphs 64 are shown for two different channel analog inputs 62 wherein an advanced feature touchscreen 66 is included for the user to modify data appearance and format. Lastly, a wireless touchscreen icon 68 is provided for wireless operation 68.

It is contemplated for embodiments of the invention to extend to individual elements and concepts described herein, independently of other concepts, ideas or system, as well as for embodiments to include combinations of elements recited anywhere in this application. Although illustrative embodiments of the invention have been described in detail herein with reference to the accompanying drawings, it is to be understood that the invention is not limited to those precise embodiments. As such, many modifications and variations will be apparent to practitioners skilled in this art. Accordingly, it is intended that the scope of the invention be defined by the following claims and their equivalents. Furthermore, it is contemplated that a particular feature described either individually or as part of an embodiment can be combined with other individually described features, or parts of other embodiments, even if the other features and embodiments make no mentioned of the particular feature. This, the absence of describing combinations should not preclude the inventor from claiming rights to such combinations.

In general, the routines executed to implement the embodiments of the invention, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processors in a computer, cause the computer to perform operations necessary to execute elements involving the various aspects of the invention. Moreover, while the invention has been described in the context of fully functioning computers and computer systems, those skilled in the art will appreciate that the various embodiments of the invention are capable of being distributed as a program product in a variety of forms, and that the invention applies equally regardless of the particular type of machine or computer-readable media used to actually effect the distribution. Examples of computer-readable media include but are not limited to recordable type media such as volatile and non-volatile memory devices, USB and other removable media, hard disk drives, optical disks (e.g., Compact Disk Read-Only Memory (CD ROMS), Digital Versatile Disks, (DVDs), etc.), and flash drives, among others.

Although the present invention has been described with reference to specific exemplary embodiments, it will be evident that the various modification and changes can be made to these embodiments without departing from the broader spirit of the invention. Accordingly, the specification and drawings are to be regarded in an illustrative sense rather than in a restrictive sense.

What is claimed is:

1. A handheld measurement system comprising:
a portable device internally housing both a data collector and an analyzer including an digital display;
said data collector capable of receiving data from one or more external test inputs for a selected measurement routine and storing said collected data for later retrieval and analysis by said analyzer;
said analyzer further processing said collected data by performing calculations for determining test results for said measurement routine, wherein said calculated results may be viewed from said digital display of said portable device transferred directly or wirelessly to any other digital display used with any other computer system.

2. The handheld measurement system according to claim 1, wherein said one or more external test inputs are analog sensors.

3. The handheld measurement system according to claim 1, wherein said analyzer is a spectrum analyzer.

4. The handheld measurement system according to claim 1, wherein said analyzer retrieves and processes said collected data using filtering techniques associated with said sensors.

5. The handheld measurement system according to claim 1, wherein said analyzer performs calculations using said collected data for determining the absence or presence of a machine system defect.

6. The handheld measurement system according to claim 1, wherein said digital display provides one or more different visual representations of the calculated results with respect to the collected measured data or.

7. The handheld measurement system according to claim 1, wherein said portable device uses a master and slave module as part of the data collection system.

8. The handheld measurement system according to claim 1, wherein said portable device houses between 4 to 8 analog input ports for receiving said input signals.

9. The handheld measurement system according to claim 1, wherein said portable device based on inputs from a user identifies a machine system and corresponding test point to be monitored wherein said portable device automatically sets up the device to record predetermined measurement parameters for said test point.

10. The handheld measurement system according to claim 1, wherein said data collector capable of conducting predetermined analysis and storing a predetermined set of data for a specific measurement test.

11. The handheld measurement system according to claim 1, wherein said portable device internally uses a transform processor for sending collected data to display processing modules for formatting data results for delivering said data results to one or more selected externally selected display's.

12. The handheld measurement system according to claim 1, wherein said digital display uses a USB protocol subsystem for delivering the same collected data results directly or wirelessly in real time to one or more USB ported devices.
